(19) United States
(12) Patent Application Publication
(10) Pub. No.: US 2016/0213026 A1
(43) Pub. Date: Jul. 28, 2016

(54) FROZEN CONFECTIONARY PRODUCT

(71) Applicant: NESTEC S.A., Vevey (CH)

(72) Inventors: Lucille Lepagnol, Beauvais (FR); Maud Isabelle Lallemand, Beauvais (FR); Max Michel Puaud, Pisseleu (FR)

(21) Appl. No.: 14/915,392

(22) PCT Filed: Aug. 14, 2014
(86) PCT No.: PCT/EP2014/067383

§ 371 Date: Feb. 29, 2016

(30) Foreign Application Priority Data
Aug. 28, 2013 (EP) 13182058.1

(51) Int. Cl. A23G 9/46; A23G 9/40; A23G 9/32

(52) U.S. Cl. CPC A23G 9/46; A23G 9/327; A23G 9/40; A23V 2002/00

(57) ABSTRACT

The present invention relates to an aerated frozen confectionary product with an overrun between 20% to 140% by volume, comprising from 4 to 23 wt % fat; from 2 to 0.1 wt % protein, from 4 to 50 wt % of a sweetening agent and from 0 to 3 wt %, preferably from 0.1 to 3 wt % of natural stabilizer; characterised in that the product is essentially free from emulsifiers, non natural stabilizers, eggs, whey and milk sources other than cream, which is the main dairy ingredient of the product. The invention is also concerning the method for the manufacture of such a frozen confectionary product as well as the process of making such stable clean label product.

### FIELD OF INVENTION

The present invention relates to a frozen confectionary product essentially free from emulsifiers and from non natural stabilisers, wherein the main source of dairy protein is cream. The present invention also relates to a method of manufacture for this frozen confectionary product and to deliver a stable clean label frozen confection.

### BACKGROUND OF THE INVENTION

Cleaner or clean label products are becoming more and more popular among ice cream consumers. The demand is, in particular, directed to products that are free from artificial ingredients such as flavours, colours and emulsifiers, defined as “additives” or ingredients with so-called “E-numbers”.

While the replacement of artificial flavours and colours by natural ingredients may not have a major impact on the key attributes of the product, the functionality of stabilizers and emulsifiers is such that their replacement by natural ingredients is very challenging. In fact, those ingredients play an important role in terms of texture, scoopability, melting behavior, heat shock resistance and shelf life of the frozen confectionary products.

The term “heat shock” as used herein, unless otherwise indicated, means the temperature fluctuations related to the storage and transportation of frozen confections. Heat shock can be simulated by treating a frozen ice cream product to temperature cycling of about −8 C to about −20° C. every 12 hours, with 30 min temperature ramp time for a period of about two weeks, or by any other method commonly used in the industry.

Efficient stabiliser compositions well known and widely used in any range of frozen confectionary products include ingredients, in particular emulsifiers, defined as “additives” or ingredients with so-called “E-numbers”. Examples of such additives often found in frozen confectionary formulations include mono- and diglycerides of fatty acids, esters of mono- and digylcerides of fatty acids, polyglycerol esters of fatty acids, polysorbates etc. They have certain drawbacks. These emulsifiers are in fact perceived as “non-natural” ingredients, deemed to be unhealthy in the eyes of the consumer. The presence of these ingredients in frozen confection recipes leads to reduced authenticity of the frozen confectionary products.

Natural emulsifiers are known but they are not as efficient as any known additives to stabilize frozen confections and their use has therefore been limited heretofore to products easier to stabilize such as “premium” or “super premium” products. There is an increasing demand for products that are natural. The most common natural emulsifier for super premium ice cream is egg yolk. Egg is a major allergen. Therefore, the use of egg yolk prevents people allergic to egg yolk from eating such super premium ice cream. The other commonly used natural emulsifier is acacia gum. Unfortunately, acacia gum is classified as additive.

For example, EP 2025240 discloses a natural stabiliser system that can be used in the manufacture of natural frozen confectionary products. The stabiliser system of EP 2025240 comprises native rice starch and fibres from vegetables, fruits or mixtures thereof. Starch is a carbohydrate and the use of starch is a non traditional component of frozen confectionary products.

There is a need to deliver a composition of frozen confectionary products that can be consumed by people allergic to egg yolk that are made with natural ingredients.

There is also a need to deliver frozen confectionary products made with natural ingredients that are not additives.

There is a further need to deliver frozen confectionary products prepared with a small number of ingredients to deliver quality and simplicity that are key criteria for naturalness.

The invention provides a solution to the above-mentioned problems.

The ice creams currently available on the market contain whey and milk sources such as skim milk powder and/or sweet whey powder. The traditional ingredients for frozen confectionary products can also comprise artificial emulsifiers, and/or natural ingredients such as natural emulsifiers such as egg yolk, which is a major allergen and/or natural stabilizers. The product of the present invention is free from these ingredients and still has the texture, scoopability, melting behaviour, heat shock resistance and shelf life of the frozen confectionary products comprising the above listed ingredients. This product is essentially free from emulsifiers, non natural stabilizers, eggs, whey and milk sources other than cream, which is the main dairy ingredient of the product. This stable ice cream product is made even by avoiding the use of four common ingredients (skim milk powder, sweet whey powder, emulsifiers and carrageenan) in the recipe.

Consumers are looking for naturalness and simplicity. Less ingredients in a recipe means a shorter ingredient list on a food packaging. Food labels are more likely to be read by people trying to avoid certain foods, ingredients or production methods compared to those less concerned by such factors. Using cream as sole dairy ingredients results in a short and simple ingredient list.

### SUMMARY OF INVENTION

In a first aspect, the invention relates to an aerated frozen confectionary product with an overrun between 20% to 140% by volume, comprising from 4 to 23 wt % of fat; from 2 to 0.1 wt % of protein; from 4 to 50% of sweetening agent and from 0 to 3 wt %, preferably from 0.1 to 3 wt %, of natural stabiliser.

According to a second aspect, the invention relates to a process for the preparation of such a product, comprising the steps of:

a) providing an ingredient mix comprising from 4 to 23 wt % fat, from 2 to 0.1 wt % protein, from 4 to 50 wt % of a sweetening agent and from 0 to 3 wt %, preferably from 0.1 to 3 wt % of natural stabiliser;
b) pasteurizing and homogenizing the mix;
c) freezing while aerating the mix;
d) optionally hardening the confectionary product.

The invention also relates to the use of an ingredient mix comprising from 4 to 23 wt % fat; from 2 to 0.1 wt % protein, from 4 to 50 wt % of a sweetening agent and from 0 to 3 wt %, preferably from 0.1 to 3 wt % of natural stabiliser, essentially free from emulsifiers, non natural stabilizers, eggs, whey and milk sources other than cream, which is the main dairy ingredient of the product, as defined above.

For a complete understanding of the present invention and the advantages thereof, reference is made to the following detailed description of the invention. It should be appreciated that various aspects of the present invention are merely illustrative of the specific ways to make and use the present invention and do not limit the scope of the invention.

### BRIEF DESCRIPTION OF THE FIGURES

FIG. 1 shows the result of a melting test performed on the two products of Example 1, on fresh samples after production (TO) on one hand and on samples after heat shock cycles (HS) on the other hand compared to a reference product.

FIG. 2 shows the results of a tasting performed for the two products of Example 1 and a reference product, both after heat shock cycles.

### DETAILED DESCRIPTION OF INVENTION

In the context of the invention, “natural ingredients” is meant to designate ingredients of natural origin. These include ingredients which come directly from the field, the animals etc. They may also include ingredients which are the result of a physical or microbiological/enzymatic process (e.g. filtering, drying, centrifugation, fermentation etc.). However, they do not include ingredients which are the result of a chemical modification process.

Unless otherwise specified, percentages are meant to designate percentages of dry matter by weight.

Frozen confectionary products include ice cream, mellorine, frozen yogurt, frozen beverage, milk shake, frozen mousse, frozen fudge, frozen custard and other frozen desserts.

The aeration or overrun in the context of the invention is produced by incorporation of gas into the confectionary product. The gas can be any food grade gas such as air, nitrogen, or carbon dioxide. The overrun is defined as follows: (Reference: Robert T. Marshall, Douglas Goff and Richard W. Hartel, 2003, Ice Cream—6th Edition, Ed. Kluwer Academic/Plenum Publishers (New York), ISBN 0-306-47700-9, page 144.)

$$\% overrun = \frac{wt of mix - wt of same vol . of ice cream}{wt of same vol . of ice cream} * 100$$

In a first aspect, the present invention relates to an aerated frozen confectionary product with an overrun between 20% to 140% by volume, comprising from 4 to 23 wt % fat; from 2 to 0.1 wt % protein, from 4 to 50 wt % of a sweetening agent and from 0 to 3 wt %, preferably from 0.1 to 3 wt % of natural stabilizer; and the product is essentially free from emulsifiers, non natural stabilizers, eggs, whey and milk sources other than cream, which is the main dairy ingredient of the product.

In this embodiment the main dairy ingredient of the product is cream, which is delivering at least 4 wt % fat in the recipe. This stable ice cream product is made even by avoiding the use of four common ingredients (skim milk powder, sweet whey powder, emulsifiers and carrageenan) in the recipe. The texture is smooth and the product is creamy and milky in the mouth. It is believed that the air bubbles are stabilized by a strong fat network coming from cream. Phospholipids present in the cream could play an important role at interfaces.

The applicant surprisingly found that stable frozen confectionary products could be obtained, wherein the product comprises natural stabilizers and essentially free from emulsifiers, non natural stabilizers, eggs, whey and milk sources other than cream, which is the main dairy ingredient of the product. Frozen confectionary product designates in the context of the invention products with a minimum overrun of 20% and a protein content lower than 2%. This finding is even more surprising in view of the fact that proteins being known and having been widely used for their emulsifying properties, one could have thought that increasing the amount of protein would have improved the stability of the products. Unexpectedly, it has been observed, that even with lower amounts of proteins product maintained its stability.

The invention therefore presents the advantage of offering the possibility to maintain the stability of frozen confectionary products while reducing their costs by lowering the amount of proteins therein.

The product of the invention is first of all characterised by an overrun between 20% to 140% by volume. According to a particular embodiment, the overrun is between 30% to 140% by volume, preferably between 50% to 140% by volume, more preferably between 80% to 140% by volume, and most preferably it is comprised between 100 and 140%.

The product of the invention has a protein content from 2 to 0.1 wt %, preferably from 1.5 to 0.1 wt % and more preferably from 1 to 0.1 wt %.

In the first embodiment of the invention, the product is essentially free from eggs, whey or milk sources such as skim milk powder and/or sweet whey powder, emulsifiers and carrageenan.

Fat is present in the products of the invention in an amount comprised between 4 wt % and 23 wt %, preferably between 7 wt % and 20 wt %, more preferably between 9 and 14 wt %. Fat can be from a dairy source, or mixtures of a vegetable source and a dairy source. Examples of fat include fresh cream, sour cream, cultured cream, butter, concentrated butter, cocoa butter, coconut oil, hazelnut oil, palm oil, palm kernel oil, rapeseed oil, soybean oil and sunflower oil. Knowing that the fat content of the cream used may vary between 30 and 40%, the cream content of the product of the invention is preferably between 10 and 77%,—if a cream with a lower fat content is used, this can be compensated by a higher cream content or by the addition of vegetable fats—the main fat source generally being the cream, however.

The frozen products of the invention also include sugars as part of a sweetening agent. By “sweetening agent” is to be meant a mixture of ingredients which imparts sweetness to the final product. Suitable sweetening agents include sugar, glucose syrups, and natural sugars like cane sugar, beet sugar, molasses, other plant derived nutritive sweeteners and natural non-nutritive high intensity sweeteners.

In particular, the sugars used in the present invention include mono- and di-saccharides.

The product further comprises from 0 to 3 wt % of natural stabilizer.

Descriptions of “emulsifier” and “stabilizer” are given by Robert T. Marshall, Douglas Goff and Richard W. Hartel, 2003, in Ice Cream—6th Edition, Ed. Kluwer Academic/Plenum Publishers (New York), ISBN 0-306-47700-9, (Chapter 3, pages 80 to 86.)

According to one embodiment, the product of the invention is essentially free from any stabilizers.

According to another embodiment, the product of the invention comprises from 0.1 to 3 wt % of a natural stabilizer.

The product of the invention is essentially free from emulsifiers or non natural stabilizers or eggs.

According to a particular embodiment, the product of the invention is essentially free from additives selected from the group consisting of mono- and diglycerides or fatty acids, sucrose esters of fatty acids, polyglycerol esters of fatty acids, polyglycerol polyricinoleate, polyethylene sorbitan mono-oleate, polysorbate 80, propylene glycol monostearate, chemically extracted lecithin, modified starch and acacia gum. According to another embodiment, the product is further essentially free from carrageenan and/or gelatine.

“Essentially free” as used here-in means that these materials are not intentionally added for their conventional properties imparting abilities, i.e. stabilizing, although there could be unintended minor amounts present without detracting from the performance of the products. Generally and preferably, the products of the invention will not contain any non-natural materials.

Examples of natural stabilizer that can be used in the context of the invention include natural gums such as pectin, guar gum, locust bean gum, tara gum, xanthan gum, arabic gum, quillaia gum and agar or any mixtures thereof.

The invention present the advantage of performing independently of the nature of the natural stabilizer, i.e. even when the product does not contain any of it.

According to another embodiment, the product of the invention does not contain starch.

According to another embodiment, the product of the invention does not contain any stabilizers.

The applicant has surprisingly found that with cream as main dairy protein source, the product according to the invention had good stability. Stability can in particular be revealed looking at the melting behaviour of the product after a heat shock treatment. The melting behaviour of the products according to the invention subjected to heat shock is good.

The applicant has also surprisingly found that even with cream as sole dairy protein source and without the use of whey, milk or other dairy protein sources other than cream, the product of the invention had good stability. The source of proteins of the recipe is mainly cream with no additional dairy protein source. The texture of the product is smooth and the product is creamy and milky in the mouth. Without wishing to be bound by a theory, it is thought that the air bubbles are stabilized by a strong fat network coming from cream. Phospholipids present in the cream could play an important role at interfaces. The shape retention of the product is very good through the time.

In a second aspect, the invention relates to a method for the manufacture of the frozen confectionary product as defined above.

In a first step of the method, a frozen confectionary ingredient mix comprising from 4 to 23 wt % fat, from 2 to 0.1 wt % protein, from 4 to 50 wt % of a sweetening agent and from 0 to 3 wt %, preferably from 0.1 to 3 wt % of natural stabiliser, and the product is essentially free from emulsifiers, non natural stabilizers, eggs, whey and milk sources other than cream, which is the main dairy ingredient of the product; are blended together to form a mix.

Following the formation of the mix, a pasteurisation step and a homogenisation step are carried out on the mix. It is not important in which order the pasteurisation step and the homogenisation step are carried out.

The pasteurisation step is carried out under standard pasteurisation conditions as known in the art.

Homogenisation is preferably carried out under standard conditions, as known in the art, adapted to the fat in the formula, namely at a pressure of between 40 and 250 bars, preferably between 80 and 245 bars, more preferably between 100 and 240 bars.

The homogenised mix may then be cooled to around 2 to 8° C. by known means. The mix may further be aged for 4 to 72 h at around 2 to 6° C. with or without stirring. Optionally, the addition of flavourings, colourings, sauces, inclusions etc. may be carried out prior to the ageing step or during the freezing step. If flavourings, colourings, sauces, inclusions etc. are added, these are preferably selected from natural ingredients only.

In the next step, the mix is aerated. In a preferred embodiment, the mix may be cooled to a temperature below −3° C., preferably between −3 and −10° C., preferably at about −4.5 to −8° C. with stirring and injection of gas to create the desired overrun.

The frozen confectionary is preferably aerated to an overrun between 20% to 140% by volume, preferably between 30% to 140% by volume, more preferably between 50% to 140% by volume, even more preferably between 80% to 140% by volume, and most preferably between 100% and 140%.

The aerated mix can be subjected to freezing either using conventional freezing equipment or by a low temperature extrusion system. In this equipment, the aerated mix is cooled by extrusion at a temperature of below −11° C., preferably between −12° C. and −18° C. in a screw extruder. The screw extruder may be one such as described in WO 2005/070225. The extrusion may be performed in a single or twin screw extruder.

The frozen product is then packaged and stored at temperatures below −20° C., where it will optionally undergo hardening step during storage. Alternatively, it can be hardened by accelerated hardening step, for example via a hardening tunnel, carried out at a temperature between −20° C. to −40° C. for a sufficient time to harden the product.

According to a third aspect, the invention relates to the use of an ingredient mix comprising from 4 to 23 wt % fat; from 2 to 0.1 wt % proteins, from 4 to 50 wt % of a sweetening agent and from 0 to 3 wt %, preferably from 0.1 to 3 wt % of natural stabilizer, and the product is essentially free from emulsifiers, non natural stabilizers, eggs, whey and milk sources other than cream, which is the main dairy ingredient of the product.

The present invention is illustrated herein by reference to the following examples which should not be considered as limiting the invention.

### EXAMPLES

Tests:

Melting tests were carried on frozen confectionary products.

Results reported in examples show the pictures of melted ice cream taken during a 180 mn test at 22° C.

Heat shock test:

Heat shock stresses were applied to samples over 7 days and each heat shock cycle lasted for 24 hours with temperature variations of between −20° C. to −8° C.

Heat Shock: submitted to heat shock stresses.

Fresh: kept frozen, without T° stress after production.

### Example 1

Aerated frozen confectionary products with natural stabilizer, no emulsifier, no skimmed milk and no sweet whey powders.

Three aerated frozen confections were prepared based on the following recipes:

TABLE 1a

| | Product ref. | | |
|---|---|---|---|
| | Reference | | |
| | % dry | Recipe 1 | Recipe 2 |
| | matter by | % dry matter by | % dry matter by |
| | weight in end | weight in end | weight in end |
| Ingredients | product | product | product |
| Dairy cream | 10.1 | 12.6 | 11.3 |
| Skimmed milk | 8.42 | 0.0 | 0.0 |
| and sweet | | | |
| whey | | | |
| Sugars & | 24.75 | 28.1 | 29.5 |
| glucose syrups | | | |
| Emulsifier | 0.22 | 0.0 | 0.0 |
| Natural | 0.17 | 0.16 | 0.16 |
| stabilisers (gums) | | | |
| Colors/flavouring | 0.12 | 0.12 | 0.12 |
| Total solids | 40.7 | 40.9 | 41.1 |
| Dairy fat | 8.6 | 10.5 | 9.5 |
| (from cream) | | | |
| Dairy protein | 2.3 | 0.8 | 0.7 |

Method:

Conventional mix proceedings, homogenisation and pasteurization were used, as well as freezing in a continuous freezer.

In particular, following blending, the 2 mixes were homogenized at pressures according to Danisco Technical Memorandum TM 2001-1e, and then pasteurised using a continuous plate heat-exchanger (at 81 to 87° C. for 30 to 36 seconds). Mixes were aged from 18 to 32 hours, in chilled conditions. Each mix was frozen on a Hoyer KF 80 continuous freezer. An overrun of 105% was provided. Each ice cream was then hardened in a ventilated hardening cell at −30° C. to −40° C.

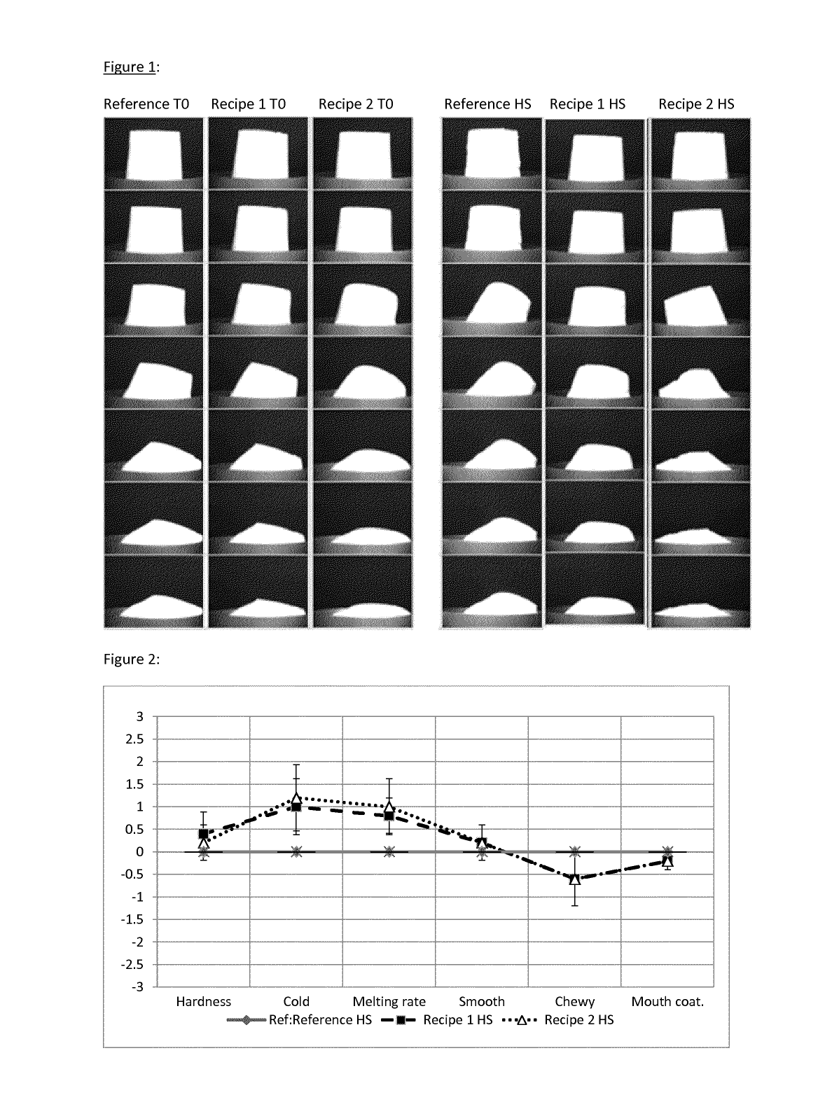

Melting test as described above was performed on the 3 products on fresh samples after production on the one hand, and on samples after heat shock treatment on the other hand. The results are represented in FIG. 1. On the left, the results on fresh samples are shown for—from left to right—the reference product, recipe 1 and recipe 2. On the right, the results for heat shocked products are shown.

It can be seen that even without the use of skimmed milk, sweet whey and emulsifier, the ice cream has good melting resistance, even after heat shock.

FIG. 2 shows the result of a tasting test which was performed on the three products described in the Example above, i.e. the reference product, recipe 1 and recipe 2. It shows the mean of taster scores.

The tasting was done after a heat shock test as described above.

The tasting panel consisted of five people who are trained for ice cream tasting. For each sensory attribute (hardness, coldness, melting rate, smoothness, chewiness, mouth coating) the value was set to 0 for the reference product, with values from −3 to +3 being possible for the difference between the tested product and the reference. A positive score was given when the attribute was perceived as more intense for the test sample, and a negative score was given if the attribute was perceived as less intense for the test sample than for the reference. The absolute value of difference can be thus be 0 (no difference perceived vs reference), 1 (slight difference), 2 (clear difference), 3 (very big difference). It appeared clearly in the test that both recipe 1 and recipe 2 have attributes which are very close to the reference product.

This means that the product according to the invention has a good texture and scoopability. The shelf life is also comparable to the reference product.

1. An aerated frozen confectionary product with an overrun between 20% to 140% by volume, comprising from 4 to 23 wt % fat, from 2 to 0.1 wt protein, from 4 to 50 wt % of a sweetening agent and from 0 to 3 wt %, of natural stabilizer, the product is essentially free from emulsifiers, non natural stabilizers, eggs, whey and milk sources other than cream, which is the main dairy ingredient of the product.

2. A product according to claim 1, wherein the amount of protein is between 1.5 to 0.1 wt %.

3. A product according to claim 1, wherein the amount of cream is between 9.5 to 80%.

4. A product according to claim 1, wherein the product does not contain any stabilizer.

5. A product according to claim 1, wherein the product does not contain starch.

6. A product according to claim 1, wherein the product is essentially free from additives selected from the group consisting of mono- and diglycerides of fatty acids, sucrose esters of fatty acids, polyglycerol esters of fatty acids, polyglycerol polyricinoleate, polyethylene sorbitan mono-oleate, polysorbate 80, propylene glycol monostearate chemically extracted lecithin, modified starch and acacia gum.

7. A product according to claim 1, wherein the product is essentially free from carrageenan and/or gelatine.

8. A product according to claim 1, wherein the overrun is between 30% to 140% by volume.

9. A product according to claim 1, wherein the amount of fat is in the range of 7 to 20 wt %.

10. A product according to claim 1, wherein the fat is selected from the group consisting of dairy fats and mixtures of vegetable and dairy fats.

11. A process for the preparation of a product comprising the steps of:
providing an ingredient mix comprising from 4 to 23 wt % fat, from 2 to 0.1 wt % protein, from 4 to 50 wt % of a sweetening agent and from 0 to 3 wt % of natural stabilizer;
pasteurizing and homogenising the mix; and
freezing while aerating the mix.

12. A process according to claim 11, wherein the freezing step is followed by a dynamic cooling of the mix to a temperature below −11° C. in an extruder.

13. A product obtainable by the process of claim 11.

14. A method for preparing a stable frozen confection comprising using from 4 to 23 wt % fat, from 2 to 0.1 wt %_protein, from 4 to 50 wt % of a sweetening agent and from 0 to 3 wt %, preferably from 0.1 to 3 wt % of natural stabilizer, to prepare a frozen confection.

15. A process according to claim 11 comprising the step of hardening the product.
